(19) United States
(12) Patent Application Publication
(10) Pub. No.: US 2008/0257675 A1
(43) Pub. Date: Oct. 23, 2008

(54) Hydrodynamic clutch arrangement

(75) Inventors: Christoph Sasse, Schweinfurt (DE); Bernd Reinhardt, Schonungen/Forst (DE); Gregor Sueck, Sennfeld (DE); Oliver So, Schweinfurt (DE); Monika Rossner, Donnersdorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/148,193

(22) Filed: Apr. 17, 2008

(30) Foreign Application Priority Data
Apr. 18, 2007 (DE) 10 2007 018 273.4

(51) Int. Cl. F16D 33/00

(52) U.S. Cl. 192/3.29

(57) ABSTRACT

A hydrodynamic clutch arrangement includes a clutch housing which can rotate about an axis of rotation; a hydrodynamic circuit formed by a pump wheel and a turbine wheel in the clutch housing; and a bridging clutch which can be actuated to establish and release a working connection between a drive and a takeoff. First flow routes connect the hydrodynamic circuit and a pressure space to at least one pressure medium reservoir, wherein said first flow routes serve to fill the clutch housing with pressure medium for actuating the bridging clutch. A second flow route carries pressure medium out of the clutch housing during an operating state, and a flow reducer in the second flow route closes to at least impede flow out of clutch housing in a non-operating state.

### BACKGROUND OF THE INVENTION

1. Field of the Invention

The invention pertains to a hydrodynamic clutch arrangement including a clutch housing which can rotate about an axis of rotation, a hydrodynamic circuit formed by a pump wheel and a turbine wheel in the clutch housing, and a bridging clutch which can be actuated to establish and release a working connection between a drive and a takeoff.

2. Description of the Related Art

A hydrodynamic clutch arrangement of this type, as known from U.S. Pat. No. 7,143,879, is used to make or break a working connection between a drive, such as the crankshaft of an internal combustion engine, and a takeoff, such as a gearbox input shaft, and is provided with a clutch housing, which rotates around an axis of rotation. In U.S. Pat. No. 7,143,879, the clutch arrangement is designed as a hydrodynamic torque converter, in which a hydrodynamic circuit is provided with a pump wheel, a turbine wheel, and a stator. In addition, the hydrodynamic clutch arrangement is provided with a bridging clutch, by means of which the hydrodynamic circuit can be bypassed for the transmission of torque from the drive to the takeoff, where a torsional vibration damper with two sets of damping springs to damp torsional vibrations is assigned to the bridging clutch.

The hydrodynamic torque converter described in U.S. Pat. No. 7,143,879 illustrates a development tendency frequently applied in recent years to hydrodynamic clutch arrangements, according to which a torus space enclosed by a pump wheel, a turbine wheel, and a stator has only limited dimensions, so that the clutch arrangement will have a more compact design. At the same time, a large bridging clutch is required to transmit high torques, and thus a highly effective and therefore complex torsional vibration damper is also required. These two components occupy a large amount of space in the clutch arrangement.

During the prolonged periods when a motor vehicle with a hydrodynamic clutch arrangement is idle, a considerable portion of the fluid present in the clutch housing leaves the clutch housing and flows into the associated gearbox. When the vehicle is started up again, the fluid remaining in the clutch housing is first distributed within the clutch housing by centrifugal force. Only a portion of this fluid thus arrives in the torus space, where it is available for the transmission of torque. This problem is made even worse when the transmission is shifted into “Drive” (D), because, as a result, the drive goes into action at a predetermined rotational speed, whereas the takeoff and thus the torsional vibration damper remain at least essentially at rest. In spite of the centrifugal force being generated, fluid is thus drawn off through the torsional vibration damper in the radially inward direction, which, in principle, should be compensated by fluid being drawn from the torus space. It is true that, in cases where the hydrodynamic clutch arrangement is designed as a two-line system, fresh fluid is introduced during this operating state into the clutch housing from a fluid reservoir via the opened bridging clutch. However, this fluid does not reach the torus space either but instead is also suctioned off radially toward the inside. When the vehicle is being driven off, these conditions are expressed by the almost complete inability of the torus space, which is more-or-less empty, and the bridging clutch, which is open, to transmit the torque being introduced from the drive to the takeoff. Only the drag torque present in the bridging clutch is able to ensure the transmission of a certain residual amount of torque. Only as the clutch continues to fill up at a slowly increasing rate does fresh fluid begin to enter and to fill the torus circuit. This type of performance characteristic cannot be tolerated in a modern motor vehicle.

### SUMMARY OF THE INVENTION

The invention is based on the task of designing a hydrodynamic clutch arrangement in such a way that, when the motor vehicle is to be started up, it can be ensured, even after the passage of a certain minimum idle time, that there will be a sufficient amount of fluid in the clutch space and that therefore it will be possible for a satisfactory amount of torque to be transmitted.

This task is accomplished by providing at least one of the flow routes serving to carry a flow medium out of the clutch housing during the operating state of the clutch arrangement with a flow volume-reducing means, which has the effect of at least delaying the decrease in the volume of medium filling the clutch housing at least during the nonoperating state. When the motor vehicle in which the hydrodynamic clutch arrangement is installed is turned off and thus at the beginning of an idle period for this vehicle, only a negligibly small amount of the fluid, called “flow medium” below, contained in the clutch housing will be able to escape from the clutch housing and to enter the associated gearbox. Thus, even after long periods of idleness of the motor vehicle, at least most of the flow medium present in the clutch housing when the motor vehicle is turned off will be available for the transmission of torque upon resumption of vehicle operation. It is thus ensured that the hydrodynamic clutch arrangement will be available for use as intended at all times.

There are various ways in which a flow volume-reducing means can be realized. It is especially advantageous for the flow volume-reducing means to be provided with a flow-release device, which is located, for example, between a space in the clutch housing such as the hydrodynamic circuit and an outflow section of the flow route. During the operating state, the pressure on the side of the flow-release device facing the hydrodynamic circuit is usually higher than that on the side of the flow-release device facing the outflow section of the flow route. The latter thus forms a separating point within the flow route, by means of which, in the closed state, a pressure relationship is maintained between the hydrodynamic circuit and the outflow section of the flow release device and thus between two pressure areas. When this pressure relationship between the two pressure areas exceeds a certain value, the flow-release device should release a flow connection, whereas, until this pressure relationship reaches the value in question, the flow connection should remain closed. Because this pressure relationship considerably exceeds the value in question during the operating state of the hydrodynamic clutch arrangement, a pressure of approximately 100,000 pascals being easily present in one of the pressure areas such as on the side of the hydrodynamic circuit—a pressure which results both from the hydrodynamic processes in the hydrodynamic circuit and from the supply of oil by a gear pump—it is possible for a pressure to remain in the same pressure area outside the operating state, namely, a pressure of approximately 1,000 pascals, which arises solely on the basis of the static pressure exerted by the quantity of the flow medium remaining in the clutch housing, and which is only a fraction of the pressure present during the operating state. As a result, the flow-release device has the ability, in the operating state of the hydrodynamic clutch device, to release the flow connection and thus open the flow route, thus allowing the unhindered exchange of the flow medium already present in the clutch housing for fresh flow medium, or, conversely, outside the operating state, at least essentially to block the flow route and thus to keep the flow medium remaining in the clutch housing—or at least a significant portion of it—inside the clutch housing.

According to an especially advantageous embodiment of the flow-release device, the device is designed as a seal with a certain flow-release section, which, as a result of its resistance to deformation, at least essentially blocks a flow connection between the two pressure areas until the pressure relationship reaches a predetermined value, whereas, when the pressure relationship exceeds the predetermined value, the flow-release section is deflected, thus releasing the flow route and allowing the pressures to equalize.

According to an especially advantageous embodiment of the flow-release device, the device acts not only as a function of the prevailing pressure relationship but also as a function of centrifugal force. Thus, the centrifugal force acting during the operating state can support the deflection of the flow-release section and thus help to unblock the flow route and to allow the pressures to equalize whereas, when the vehicle is in the nonoperating state and there is no centrifugal force present, there will be no interference with the ability of the flow-release device at least essentially to prevent a flow connection from developing between the two pressure areas until the pressure relationship reaches the predetermined value.

Alternatively, the flow volume-reducing means can be provided with a flow passage with a flow-through volume which is formed by flow passageways of a predetermined small number or of a predetermined small cross section. Although it is true as a result that flow medium can seep through the flow passageways into the gearbox assigned to the hydrodynamic clutch device, the volume flow rate of this seeping flow medium is much smaller than that which occurs when the conventional large number of flow passageways is used or when these flow passageways are designed with the conventional cross-sectional area.

An especially advantageous location for positioning the inventive flow volume-reducing means is the radially inner area of the clutch housing, namely, in the transition area between the hydrodynamic circuit and a flow route. A location adjacent to a freewheel, which holds a stator between the pump wheel and the turbine wheel, is preferred, and even more highly preferred is a location adjacent to a bearing between the freewheel of the stator and an axially adjacent component, such as the hub which holds the turbine wheel and/or a torsional vibration damper. Because of its function, this hub is to be referred to below as the “carrier hub”. To prevent the unwanted escape of flow medium via the previously mentioned bearing, a sealing device which at least essentially prevents the passage of flow medium can be assigned to this bearing. It is especially preferable for tolerance-related gaps between the bearing and the adjacent component, such as a thrust washer, to be reduced to a minimum, even more preferably to zero, by appropriate manufacturing measures. In this case, the gaps themselves also act as a flow volume-reducing means.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows the upper half of a longitudinal cross section through a clutch housing of a hydrodynamic clutch device with a plurality of flow routes for fluid medium;

FIG. 2 shows an enlarged view of the area in the circle designated “X” in FIG. 1, which illustrates a flow route with a seal in the immediate vicinity of a thrust washer integrated into the flow route, the seal being shown under the action of low pressure;

FIG. 3 is the same as FIG. 2 except that it shows a seal at a higher pressure;

FIG. 4 shows a plan view of the thrust washer in FIG. 2, looking in direction A, with the formation of a flow passage according to the prior art, where this flow passage has a plurality of flow passageways of predetermined number and of predetermined cross-sectional area;

FIG. 5 is the same as FIG. 4, except that it shows the inventive reduction of the cross-sectional area of the flow passageways in the flow passage;

FIG. 6 is the same as FIG. 4, except that it shows the inventive reduction of the number of flow passageways in the flow passage; and

FIG. 7 is the same as FIG. 2, except that it shows a sealing device assigned to the bearing and a minimized axial gap between the bearing and a component of the clutch arrangement.

### DETAILED DESCRIPTION OF THE PRESENTLY PREFERRED EMBODIMENTS

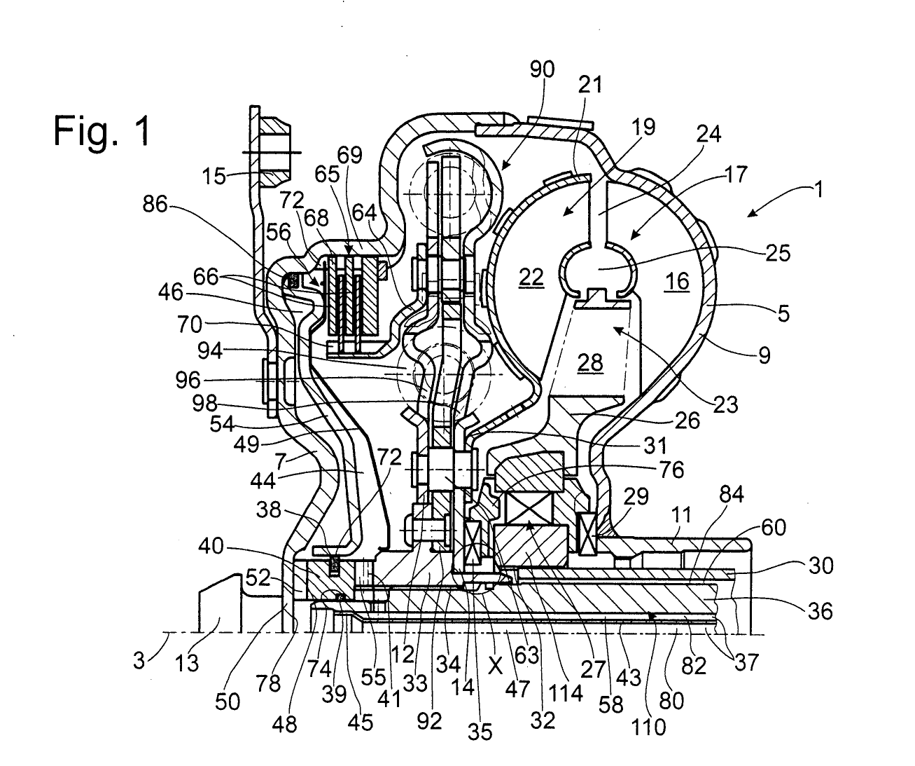

FIG. 1 shows a hydrodynamic clutch device 1, designed as a hydrodynamic torque converter. The hydrodynamic clutch device 1 has a clutch housing 5, which is able to rotate around an axis of rotation 3. On the side facing a drive (not shown), such as the crankshaft of an internal combustion engine, the clutch housing 5 has a drive-side housing wall 7, which is permanently connected to a pump wheel shell 9. This merges in the radially inner area with a pump wheel hub 11.

To return to the drive-side housing wall 7: On the side facing the drive (not shown), this wall has a bearing journal 13, which, in a manner which is already known and therefore not illustrated in detail, is supported on an element of the drive, such as the crankshaft, for the drive-side mounting of the clutch housing 5. In addition, the drive-side housing wall 7 has fastening mounts 15, which serve in the conventional manner to allow the clutch housing 5 to be fastened to the drive, preferably by way of a flexplate (not shown). With respect to drawings which show the mounting of the bearing journal of a hydrodynamic clutch element in a crankshaft of a drive and the connection of the hydrodynamic clutch device by way of a flexplate to the crankshaft, reference can be made by way of example to FIG. 1 of U.S. Pat. No. 4,523,916.

The previously mentioned pump wheel shell 9 cooperates with pump wheel vanes 16 to form a pump wheel 17, which works together with, first, a turbine wheel 19 consisting of a turbine wheel shell 21 and turbine wheel vanes 22, and, second, with a stator 23. The pump wheel 17, the turbine wheel 19, and the stator 23 form a hydrodynamic circuit 24 in the known manner, which encloses an internal torus 25.

It should also be mentioned that the stator vanes 28 of the stator 23 are mounted on a stator hub 26, which is itself mounted on a freewheel 27. The latter is supported axially by an axial bearing 29 against the pump wheel hub 11 and is connected nonrotatably but with freedom of relative axial movement by way of a set of teeth 32 to a support shaft 30, which is located radially inside the pump wheel hub 11. The support shaft 30, which is itself designed as a hollow shaft, radially encloses a gearbox input shaft 36, serving as the takeoff 110 of the hydrodynamic clutch device 1, this input shaft being provided with a central bore 37. This central bore 37 holds a sleeve 43 in such a way that the sleeve 43 is centered radially in the central bore 37 by support areas 45. With an axial offset from these support areas 45, the sleeve 43 forms a first supply channel 58 for fluid medium, referred to in the following as flow medium, radially between itself and the enclosing wall of the center bore 37. In the present design of the hydrodynamic clutch arrangement 1, this supply channel acts as a supply line for the flow medium. Radially inside the sleeve 43 there remains a channel, i.e., the central supply channel 47.

The gearbox input shaft 36 has a set of teeth 34 by which it holds a hub 33 so that it cannot rotate but is free to move in the axial direction. A takeoff-side hub disk 92 of the torsional vibration damper 90 is attached to the radially outer area of the hub 33. The hub disk 92 has a set of circumferential springs 94 by which it cooperates with two cover plates 96, 98, as components 12, 14 in the clutch housing 5, where the cover plates 96, 98 are also parts of the torsional vibration damper 90. The cover plate 98 as component 14 serves to accept a turbine wheel base 31 by means of a riveted connection 63, whereas the other cover plate 96 as component 16 is designed so that an inner plate carrier 64 of a clutch device 65, which is designed as a multi-plate clutch, can be attached to it. The clutch device 65 has both inner clutch elements 66, which are connected nonrotatably to the inner plate carrier 64 by a set of teeth 70 on the carrier, and outer clutch elements 68, which can be brought into working connection with the inner clutch elements 66, where the outer clutch elements 68 are connected for rotation in common to the drive-side wall 7 and thus to the clutch housing 5 by means of a set of teeth 72, acting as an outer plate carrier 69. The clutch device 65 can be engaged and disengaged by means of an axially movable piston 54 and cooperates with the piston 54 to form a bridging clutch 56 of the hydrodynamic clutch device 1. As FIG. 1 shows, a separating plate 49 can be provided between the piston 54 and the torsional vibration damper 90 to isolate the hydrodynamic circuit 24 from a supply space 44, bounded axially by the piston 54 and the separating plate 49. On the side of the piston 54 facing away from this supply space 44, a pressure space 46 is provided, bounded axially by the piston and by the drive-side housing wall 7. The piston 54 is centered in the clutch housing 5 by a seal 86, which holds the piston in place and seals it off against the housing.

The hub 33 is called the “carrier hub” 33 in the following, because it holds not only the torsional vibration damper 90 but also, indirectly, i.e., by way of the vibration damper, the turbine wheel 19. On one side, this hub is supported against the freewheel 27 by way of the cover plate 98 and a bearing 35, which is designed as an axial bearing, and then by way of a thrust washer 76. On the other side, i.e., at the end facing the drive-side wall 7, which forms an axial bearing area 48, it can be supported axially against an axial contact surface 50 of the drive-side housing wall 7, where this axial contact surface 50 extends radially outward from the axis of rotation 3 of the clutch housing 5. The bearing journal 13 is attached to the opposite side of the drive-side housing wall 7 of the clutch housing 5, inside the area over which this axial contact surface 50 extends.

Radially on the inside, the carrier hub 33 is sealed off against the gearbox input shaft 36 by a seal 39, which is held in a seal recess 74; radially on the outside, it is sealed off against the piston 54 of the bridging clutch 56 by a seal 38, held in a seal recess 72. These two seals 38, 39 separate passages 52, which pass through the carrier hub 33 in its axial bearing area 48 and are preferably designed as grooves in the axial bearing area 48, from other flow passages 55, which are formed in the axial part of the carrier hub 33 between the piston 54 and the torsional vibration damper 90. The flow passages 52 are in flow connection with the central supply channel 47 of the sleeve 43, which acts as a central flow route 80, whereas the other flow passages 55 are in flow connection with the first supply channel 58 located radially between the sleeve 43 and the wall of the central bore 37 in the gearbox input shaft 36 surrounding the sleeve, where this supply channel 58 acts as the first flow route 82. In addition, a second supply channel 60 is provided radially between the gearbox input shaft 36 and the support shaft 30, where this channel acts in the present embodiment of the hydrodynamic clutch arrangement 1 as a discharge line for the flow medium and serves as a second flow route 84.

By way of the flow passages 52, the central flow route 80 serves to establish a positive pressure in the pressure space 46 versus the supply space 44 and thus to actuate the piston 54 of the bridging clutch 56, causing it to engage, i.e., to move toward the clutch device 65, as a result of which a frictional connection is produced between the individual clutch elements 66, 68. To generate this positive pressure in the pressure space 46 versus the supply space 44, there must be connection between the central flow route 80 and a control device and a hydraulic fluid reservoir. Neither the control device nor the hydraulic fluid reservoir is shown in the drawing, but they can be found in FIG. 1 of U.S. Pat. No. 5,575,363, which is incorporated by reference in the present patent application.

By way of the set of teeth 34 and the flow passages 55, the first flow route 82 serves to produce a positive pressure in the supply space 44 versus the pressure space 46 and thus to actuate the piston of the bridging clutch 56, causing it to disengage, i.e., to move away from the clutch device 65, as a result of which the frictional connection between the individual clutch elements 66, 68 of the clutch device 65 is released. To generate this positive pressure in the supply space 44 versus the pressure space 46, there must be a connection between the first flow route 82 and the previously mentioned control device and the previously mentioned hydraulic fluid reservoir.

Fluid medium which has arrived in the supply space 44 via the first flow route 82 and the flow passages 55 cools the clutch elements 66, 68 of the clutch device 75 and then enters the hydrodynamic circuit 24, from which it emerges again via the second flow route 84.

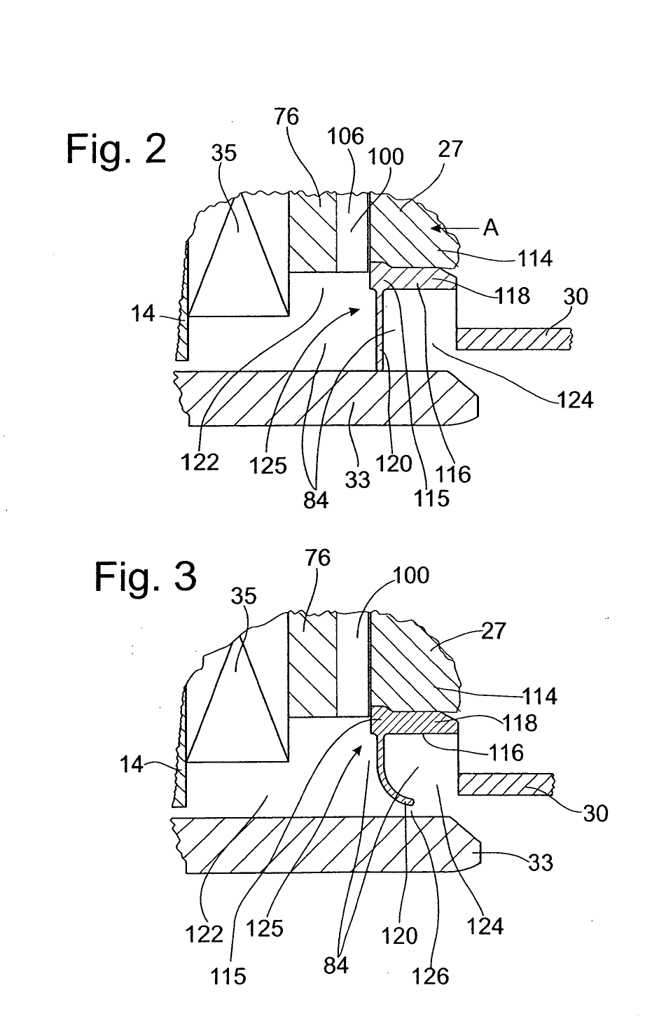

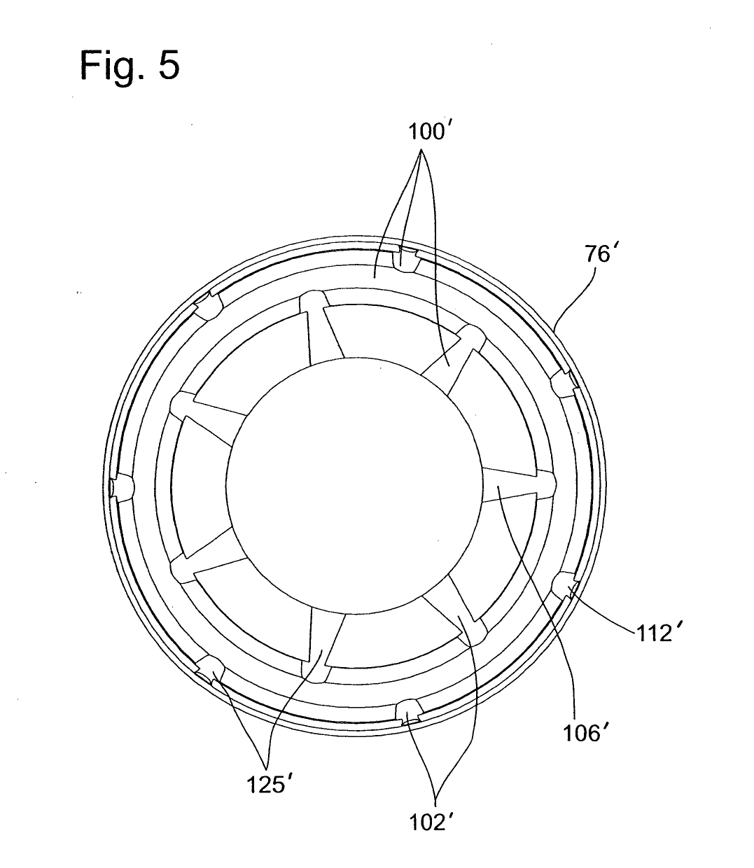

The area of the carrier hub 33 inside the circle marked “X” in FIG. 1 is shown on an enlarged scale in FIG. 2. FIG. 4 shows a thrust washer 76 according to the prior art as it would appear when looking in direction A in FIG. 2. According to FIG. 4, the thrust washer 76 has radial grooves 106 in the radially inner area, which are distributed around the circumference connected to a plurality of radially outer radial grooves 112 by way of an essentially ring-shaped connecting groove 108. The radial grooves 106 and 112 cooperate with the connecting groove 108 to form the flow passageways 102 of a flow passage 100. The cross section shown in FIG. 2 shows the thrust washer 76 with internal radial groove 106 serving as the flow passage 100.

According to FIG. 2, a seal 116 is provided radially inside an inner ring 114 of the freewheel 27 and axially adjacent to the support shaft 30. This seal has a mounting section 118 acting on the inner ring 114 and a flow-release section 120 on the mounting section. This flow-release section 120 has a certain intrinsic stiffness and therefore resists deformation as long as there is little or no pressure difference between the pressure area 122 on one side of the flow-release section and the pressure area 124 on the other side, which is the case in, for example, the nonoperating state of the hydrodynamic clutch arrangement 1. Because of this behavior of the flow-release section 120, therefore, the seal 116 can fulfill the function of a flow volume-reducing means 125. At a low pressure relationship between the two pressure areas, the flow-release section 120 performs the function of an at least essentially leak-proof separating wall between the first pressure area 122 assigned to the hydrodynamic circuit 24 and the second pressure 124 assigned to the second supply channel 60, where the two pressure areas 122 and 124 are parts of the second flow route 84. In any case, the flow-release section 120 is dimensionally stable enough that it can withstand the hydrostatic pressure prevailing in the first pressure area 122, i.e., the pressure generated by the flow medium remaining in the hydrodynamic circuit 24, during the time that the hydrodynamic clutch arrangement 1 is in the nonoperating state. In this nonoperating state there is no positive pressure in the second pressure area 124. The seal 116 significantly reduces the seepage of flow medium out of the hydrodynamic circuit 24 which would otherwise occur in the nonoperating state of the hydrodynamic clutch arrangement 1 and thus ensures that, even after long idle phases of the motor vehicle in which the hydrodynamic clutch arrangement 1 is installed, there will still be sufficient flow medium in the hydrodynamic circuit 24 to ensure that, during a subsequent restart process, it will be possible for torque to be transmitted promptly. In the normal case, approximately ⅔ of the flow medium present in the hydrodynamic circuit 24 during a relatively long period of continuous operation is sufficient to ensure that the vehicle can be driven off without difficulty. Because there is no centrifugal force present when the vehicle is not operating, there is no interference with the ability of the seal 116 to perform its function.

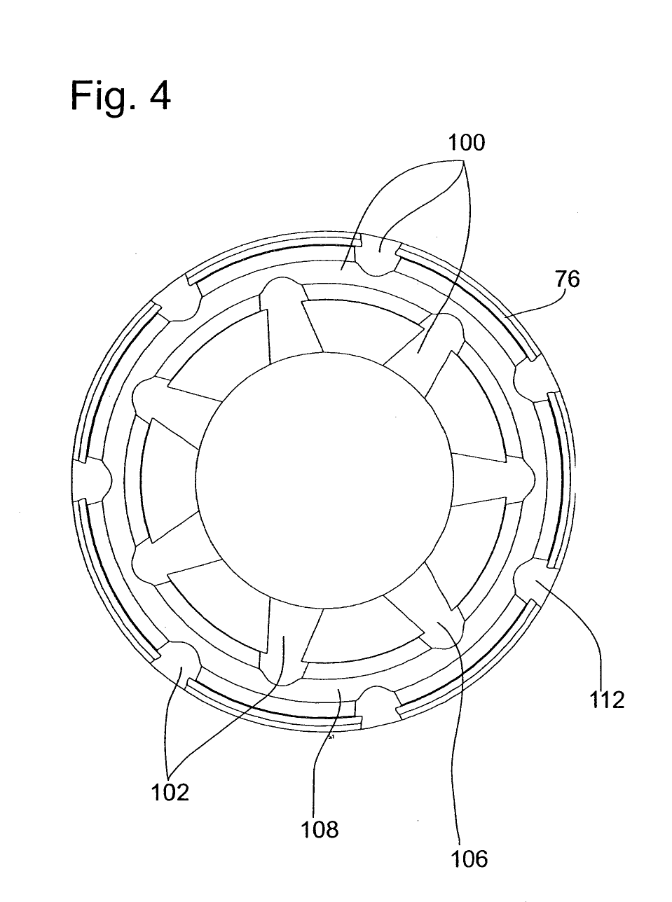

When the hydrodynamic clutch arrangement 1 is in the operating state, the pressure in the hydrodynamic circuit 24 and thus in the first pressure area 122 is much higher than it is in the nonoperating state, whereas there is still no positive pressure in the second pressure area. Because of the high pressure relationship between the first pressure area 122 and the second pressure area 124, as FIG. 3 shows, the flow-release section 120 of the seal 116 is deflected in spite of its dimensional rigidity, so that it releases the flow connection 126 between the two pressure areas 122 and 124 of the second flow route 84, the seal 116 thus acting as the flow-release device 115 of the flow volume-reducing means 125. This function of the flow volume-reducing means 125 is necessary so that, upon introduction of fresh flow medium into the hydrodynamic circuit 24 via the first flow route 82, including the flow passages 55, heated flow medium will be able to leave the hydrodynamic circuit 24 simultaneously and, when the flow-release section 120 is arranged as shown in FIG. 2 or FIG. 3, this departure will also be supported by the centrifugal force present during the operating state.

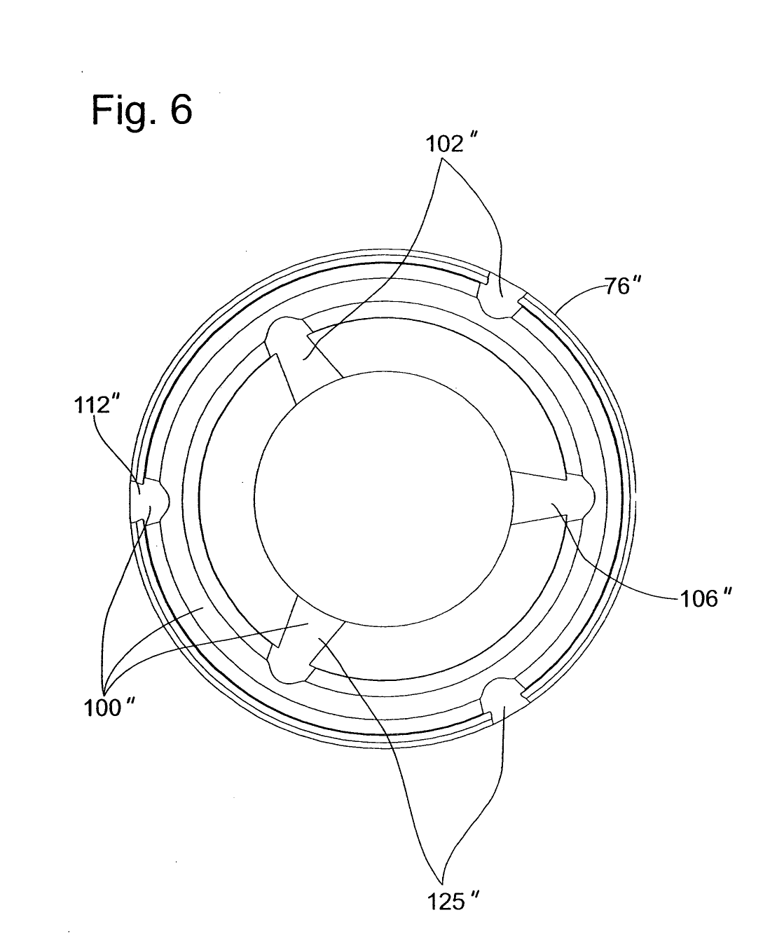

Different embodiments of the flow volume-reducing means 125 are illustrated in FIG. 5 and FIG. 6. It can be seen that the flow volume-reducing means 125′ according to FIG. 5 is created in that the flow passage 100′ formed at the thrust washer 76′ consists of flow passageways 102′ which are smaller in cross section than those shown in FIG. 4, whereas, according to FIG. 6, a smaller number of flow passageways 102″ is provided.

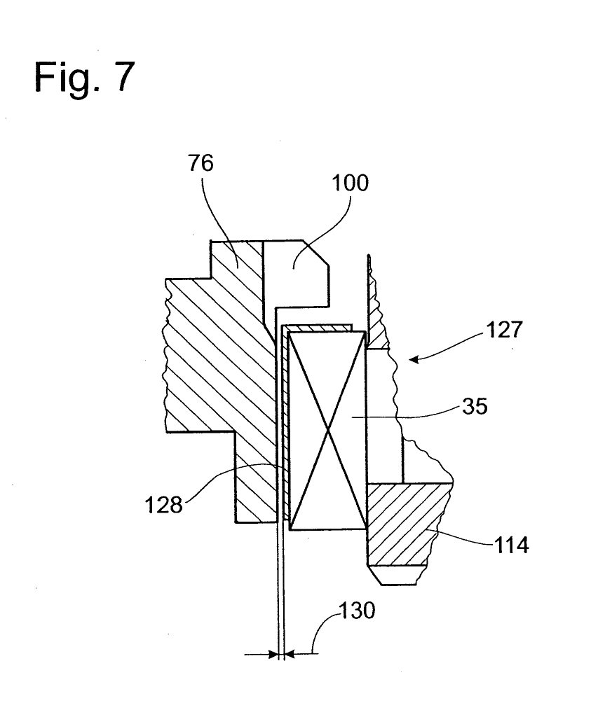

In contrast to the diagram of FIG. 2, the bearing 35 in the embodiment shown in FIG. 7 is located axially between the thrust washer 76 and the freewheel 127 of the stator 23. A sealing device 128 is assigned to the bearing 35 to prevent flow medium from passing through the bearing 35. Thus the only way in which the flow medium can flow is to take the route through a tolerance-dependent gap 130 present axially between the thrust washer 76 and the sealing device 128. To minimize the seepage of flow medium out of the hydrodynamic circuit 24 during the nonoperating state, this gap 130 should be made as small as possible by the use of appropriate manufacturing technology and should ideally approach a value of zero. Thus the undesirable escape of flow medium can be almost completely avoided in the area over which the bearing 35 extends. Minimizing the gap 130 thus represents an additional way of designing a flow volume-reducing means 125, especially when a sealing device 128 for the bearing 35 is assigned to the gap 130.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hydrodynamic clutch arrangement comprising:
a clutch housing which can rotate about an axis of rotation;
a hydrodynamic circuit formed by a pump wheel and a turbine wheel in said clutch housing;
a bridging clutch which can be actuated to establish and release a working connection between a drive and a takeoff;
a pressure space in said clutch housing;
first flow routes for connecting the hydrodynamic circuit and the pressure space to at least one pressure medium reservoir, wherein said first flow routes serve to fill the clutch housing with pressure medium for actuating the bridging clutch;
a second flow route for carrying pressure medium out of the clutch housing during an operating state; and
a flow reducer in said second flow route, said flow reducer closing to at least impede flow out of clutch housing in a non-operating state.

2. The hydrodynamic clutch arrangement of claim 1 wherein the flow reducer comprises a flow release device which opens the second flow route when a predetermined pressure is exceeded, and otherwise remains essentially closed.

3. The hydrodynamic clutch arrangement of claim 2 wherein the flow release device comprises a seal which separates two pressure areas in the second flow route, the seal having a flow release section with a predetermined resistance to deformation

4. The hydrodynamic clutch arrangement of claim 1 wherein the flow reducer a plurality of flow passageways having a predetermined cross-section.

5. The hydrodynamic clutch arrangement of claim 4 wherein the flow passageways are arranged radially between the hydrodynamic circuit and the second flow route.

6. The hydrodynamic clutch arrangement of claim 5 further comprising a freewheel for a stator in the hydrodynamic circuit, the flow passageways being located between the freewheel and an axial bearing.

7. The hydrodynamic clutch arrangement of claim 1 wherein the flow reducer comprises a bearing in the second flow route, the bearing being installed between components which can move relative to each other, and a sealing device which prevents the flow of pressure medium through the bearing.

8. The hydrodynamic clutch arrangement of claim 1 wherein the flow reducer comprises a bearing in the second flow route, the bearing being installed between components which can rotate relative to each other, the components being separated by a gap which is essentially zero.

9. The hydrodynamic clutch arrangement of claim 1 further comprising a piston for actuating the bridging clutch, the piston separating said pressure space from said hydrodynamic circuit.
